(19) United States
(12) Patent Application Publication
(10) Pub. No.: US 2018/0195898 A1
(43) Pub. Date: Jul. 12, 2018

(54) OPTIMIZATION OF THE RADIATION DISTRIBUTION OF A RADIATION SOURCE

(71) Applicant: Heraeus Noblelight GmbH, Hanau (DE)

(72) Inventors: Peter GOLD, Rottendorf (DE); Jörg DIETTRICH, Erlensee (DE); Michael PEIL, Otzberg (DE); Christian RÜTH, Mömbris (DE); Stefan MEYER, Ronneburg (DE); Enrico BREGA, Eschborn (DE); Marko HOFMANN, Hochheim (DE); Jan STRAUSS, Seligenstadt (DE)

(21) Appl. No.: 15/741,725

(22) PCT Filed: Jun. 7, 2016
(86) PCT No.: PCT/EP2016/062835

§ 371 Date: Jan. 3, 2018

(30) Foreign Application Priority Data
Jul. 8, 2015 (DE) 10 2015 212 785.0

(51) Int. Cl. G01J 1/42; G02B 7/02; G02B 19/00

(52) U.S. Cl. CPC G01J 1/4257; G02B 19/0066; G02B 7/028

(57) ABSTRACT

The invention relates to a radiation source including: an illuminant; a first optical element; and a sensor. The sensor is designed appropriately and is connected to the first optical element appropriately such that the sensor can be used to determine a change of a parameter of the first optical element over time, whereby the parameter affects an optical property of the radiation source. Moreover, the invention relates to a method for the producing a product involving the provision of a radiation source according to the invention as well as to a use of the radiation source to increase the efficiency of conversions or changes of state of educts to products.

### CROSS REFERENCE TO RELATED APPLICATIONS

This application is a U.S. National Phase filing of international patent application number PCT/EP2016/062835 filed Jun. 7, 2016 that claims the priority of German patent application number 102015212785.0 filed Jul. 8, 2015. The disclosures of these applications are hereby incorporated by reference in their entirety.

### FIELD

The invention relates to a radiation source comprising an illuminant, a first optical element, a sensor, whereby the sensor is designed appropriately and is connected to the optical element appropriately such that the sensor determines a change of a parameter of the optical element over time that affects an optical property of the radiation source. The invention further relates to a method for the producing a product involving the provision of an educt, a radiation source according to the invention, and illumination of the educt with the radiation source

### BACKGROUND

Radiation sources are utilised for a large variety of applications. The requirements with respect to the precision, durability or intensity can be very different depending on the field of use. Accordingly, one important requirement of a radiation source used for homogeneous illumination of a surface, object or liquid is the steady provision of a homogeneous emission from the radiation source. The prior art includes numerous attempts to provide for homogeneous emission, for example by checking on characteristics of the radiation source. Accordingly, DE 10 2012 008 930 A1 describes the monitoring of the illumination power of light sources by means of a camera that continuously measures the intensity of the light sources across a representative space. However, this takes into consideration only the illumination intensity of the light sources rather than that of the entire illumination system. Using this system, it is not feasible to monitor the beam distribution, which is affected by other components, such as apertures, lenses or other optical elements.

### SUMMARY

According to an exemplary embodiment of the invention, a radiation source is provided. The radiation source includes an illuminant, a first optical element, and a sensor. The sensor is designed appropriately and is connected to the first optical element appropriately such that the sensor can be used to determine a change of a parameter of the first optical element over time, whereby the parameter affects an optical property of the radiation source.

According to another exemplary embodiment of the invention, a method for producing a product is provided. The method includes the steps of: (i) providing an educt; (ii) providing a radiation source as recited in the previous paragraph; and (iii) illuminating the educt with the illuminant in order to obtain the product.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1a shows a schematic view of a radiation source according to the invention with lens as first and further optical element;

FIG. 1b shows a schematic view of a radiation source according to the invention with lens as first optical element and reflector as further optical element;

FIG. 2 shows a schematic view of a radiation source according to the invention with LED array as illuminant and lens array as further optical element;

FIG. 3 shows a schematic view of an extensometer on a bracket of the optical element;

FIG. 4 shows a schematic view of a temperature sensor in the form of a sensor chain on a bracket of the optical element;

FIG. 5 shows a schematic view of multiple separate temperature sensors on a bracket of the optical element; and

FIG. 6 shows a schematic view of the process steps of a method according to the invention.

### DETAILED DESCRIPTION

In general, it is an object of the present invention to overcome, at least in part, the disadvantages resulting according to the prior art.

It is an object to provide a radiation source that enables optimally efficient operation.

Another object is to provide a radiation source that generates the least possible maintenance needs and has a low failure rate.

It is another object to provide a radiation source that enables an optimally homogeneous distribution of radiation.

Another object is to provide a radiation source that allows the distribution of radiation to be monitored. Moreover, it is an object to enable a quality control for the illumination by a radiation source.

It is an object to provide a method for the producing a product that can be implemented efficiently, inexpensively, and safely.

A further object is to use a sensor that enables an efficient use of a radiation source.

Moreover, it is an object to optimise production procedures of products from educts. It is an object to be able to produce products, in particular the drying of objects and varnishes as well as the polymerisation of oligomers with low scrap rate and altogether more efficiently.

It is another object to provide printers with more even quality and a lower maintenance intensity.

It is another object to optimise the service life of printers.

### Embodiments

|1| A radiation source containing: an illuminant; a first optical element; and a sensor, whereby the sensor is designed appropriately and is connected to the optical element appropriately such that the sensor can be used to determine a change of a parameter of the optical element over time, whereby the parameter affects an optical property of the radiation source.

|2| The radiation source according to embodiment 111, whereby the optical element comprises a bracket and whereby the sensor is connected to the optical element by means of the bracket.

|3| The radiation source according to any one of the preceding embodiments |1| or |2|, whereby the bracket surrounds the optical element along a circumferential line over at least 50% of the circumferential line.

|4| The radiation source according to any one of the preceding embodiments |1| to |3|, whereby the bracket comprises at least 50% by weight of a metal, a ceramics, a cermet, a polymer or a combination of at least two thereof, relative to the total weight of the bracket.

|5| The radiation source according to the preceding embodiment |4|, whereby the metal is selected from the group consisting of iron, steel, copper, aluminium, magnesium, titanium, tungsten, nickel, tantalum, niobium, an alloy of at least two of these metals, an alloy of copper and zinc, lead, nickel, manganese or silicon or a mixture of at least two thereof.

|6| The radiation source according to any one of the preceding embodiments |1| to |5|, whereby the sensor is selected from the group consisting of a temperature sensor, an extensometer, an optical sensor, a capacitative sensor, an inductive sensor or a combination of at least two thereof.

|7| The radiation source according to any one of the preceding embodiments |1| to |6|, whereby the sensor is appropriately connected to the optical element such that more than 10% of the radiation emitted by the illuminant impinges on the sensor.

|8| The radiation source according to any one of the preceding embodiments |1| to |7|, whereby the sensor is appropriately connected to the optical element such that less than 20% of the radiation emitted by the illuminant impinges on the sensor.

|9| The radiation source according to any one of the preceding embodiments |1| to |8|, whereby the sensor is appropriately connected to the optical element such that an expansion of the optical element can be determined in all three directions of space.

|10| The radiation source according to any one of the preceding embodiments |1| to |9|, whereby the radiation source comprises a number of sensors in the range from 1 to 100.

|11| The radiation source according to any one of the preceding embodiments |1| to |10|, whereby the sensor is arranged on the edge of the optical element.

|12| The radiation source according to any one of the preceding embodiments |1| to |11|, whereby the sensor surrounds at least the surface of the optical element that is situated perpendicular to a main emission direction of the illuminant.

|13| The radiation source according to any one of the preceding embodiments |1| to |12|, whereby the sensor encloses the optical element along a circumferential line of the optical element.

|14| The radiation source according to any one of the preceding embodiments |1| to |13|, whereby the radiation source comprises at least three sensors.

|15| The radiation source according to the preceding embodiment |14|, whereby the at least three sensors are arranged in a plane, whereby the largest possible surface defined by the three sensors comprises at least one third of the surface of the optical element situated in the same plane as the sensors.

|16| The radiation source according to any one of the preceding embodiments |1| to |15|, whereby the length of the sensor corresponds at least to the length of the largest outer circumference of the optical element.

|17| The radiation source according to any one of the preceding embodiments |1| to |16|, whereby the optical element is selected from the group consisting of a lens, a reflector, an aperture, a prism, a mirror or a combination of at least two thereof.

|18| The radiation source according to the preceding embodiment |17|, whereby the radiation source comprises a further optical element.

|19| The radiation source according to any one of the preceding embodiments |1| to |18|, whereby the illuminant emits light in a wavelength range of 100 nm to 10 μm.

|20| A method for producing a product, comprising the steps of: Providing an educt; providing a radiation source according to any one of the claims 1 to 18; illuminating the educt with the radiation source in order to obtain the product.

|21| The method according to embodiment |20|, whereby the product is obtained through a change of state of the educt.

|22| The method according to embodiment |20|, whereby the product is obtained from the educt by a process of conversion.

|23| The method according to any one of the embodiments |20| or |21|, whereby the product is selected from the group consisting of a liquid phase, an object, a change of state of the educt.

|24| Use of a sensor for homogenisation of the beam distribution of a radiation source according to any one of the embodiments |1| to |19|.

|25| Use of a radiation source according to any one of the embodiments |1| to |19| to increase the efficiency of conversions or changes of state of educts to products.

The subject matters of the category-forming claims contribute to meeting at least one of the objects specified above. The subject matters of the sub-claims depending on said category-forming claims are preferred refinements.

A first subject matter of the present invention is a radiation source comprising: an illuminant; a first optical element; and a sensor, whereby the sensor is designed appropriately and is connected to the optical element appropriately such that the sensor can be used to determine a change of a parameter of the optical element over time, whereby the parameter affects an optical property of the radiation source, such as, e.g., the distribution of radiation.

The radiation source can be any radiation source a person skilled in the art would use to generate radiation. Preferably, the radiation source comprises a housing in order to protect, e.g., the illuminant, the first optical element or the sensor, from external influences. The housing can be made of any material a person skilled in the art would select for this purpose. Preferably, the housing comprises a material selected from the group consisting of a metal, a ceramic material, a cermet, a plastic material, a wood, a glass or a combination of at least two thereof. Preferably, the housing comprises a material selected from the group consisting of a metal, a ceramic material, a cermet, a polymer or a combination of at least two thereof. The metal, the ceramic material, the plastic material can be selected from the same list as described for the bracket. Preferably, the housing comprises a material as described for the bracket. Moreover, the housing preferably comprises at least 90% by weight aluminium, relative to the total weight of the housing. The shape of the housing can be any shape a person skilled in the art would select for this purpose. Preferably, the shape of the housing is selected appropriately such that it can accommodate all components of the radiation source and at the same time comprises an opening to allow the light of the illuminant to be utilised outside of the housing.

The illuminant can be any illuminant a person skilled in the art would use for a radiation source. An illuminant shall be understood to be a means for generating radiation that is assigned to an optical element of the radiation source each. In this context, the illuminant can comprise multiple light sources, such as, for example, one or more LEDs, for example in the form of one or more LED chips, or one or more LED arrays with a multitude of LEDs or LED chips. Likewise, the first optical element can comprise a multitude of optical units, such as lenses, reflectors, mirrors or the like. Preferably, the illuminant comprises a particular wavelength range to be able to specifically illuminate an educt. For example, this can be an illuminant in the IR range or in the UV range, but just as well in the visible range of light. The illuminant is preferably designed appropriately such that it emits light efficiently in the desired wavelength range. Preferably, the illuminant emits the light in a desired direction of space. Preferably, the illuminant comprises a main emission direction. Preferably, the main emission direction is predetermined by the orientation of the illuminant inside the radiation source. Moreover, the main emission direction of the illuminant is preferably determined by the design of the illuminant itself. If the illuminant itself does not comprise a main emission direction, the main emission direction shall be defined by the arrangement of the illuminant with respect to the first and the further element. Preferably, the main emission direction of the illuminant extends through the centres of the first and of the further optical elements. The main emission direction can be defined through arrangement of the optical elements, such as apertures, lenses, reflectors, prisms or a combination thereof.

The illuminant is preferably selected from the group consisting of a halogen lamp, a mercury vapour lamp, an LED, an LED chip, an LED array, a laser, and an energy saving lamp. Also preferably, the illuminant is selected from the group consisting of an LED, an LED chip, an LED array or a combination of at least two thereof. The LED array preferably comprises a number of LEDs in the range of 1 to 2,000 or preferably in the range of 2 to 1,500 or preferably in a range of 3 to 1,000. The illuminant preferably comprises multiple LED arrays, which preferably are arranged next to each other such that the emission direction of all LED arrays preferably is the same. Preferably, the illuminant attains an illumination intensity in the range of 1,000 mW/cm² to 15,000 W/cm² or preferably in the range of 2,000 mW/cm² to 10,000 W/cm² or preferably in the range of 5,000 mW/cm² to 5,000 W/cm², at a distance of 0.5 cm to 1 m from the illuminant. The radiation source can comprise more than one illuminant. Preferably, the radiation source comprises a number of illuminants that is in the range of 1 to 100 or preferably in the range of 2 to 50 or preferably in the range of 2 to 40.

Preferably, the illuminant is connected to a cooling unit in order to prevent the illuminant and the radiation source from overheating. The cooling unit is preferably suitable for cooling at least the illuminant to a temperature in the range of 20 to 100° C., preferably in the range of 25 to 95° C. or preferably in the range of 30 to 90° C. The illuminant preferably comprises a mount that comprises, at least in part, the respective light sources belonging to the illuminant. Preferably, the mount comprises an opening in the form of an exit opening. The mount can be selected from the same list as the materials of the housing. The mount preferably comprises the same materials as the housing of the radiation source. Preferably, the size of the illuminant and/or of the mount of the illuminant is in the range of 1 mm³ to 500 m³ or preferably in the range of 1.5 mm³ to 300 m³ or preferably in the range of 3 mm³ to 200 m³. Said volume can be determined by assuming the opening of the mount to also be closed. Also preferably, the illuminant comprises an aspect ratio of the exit window in the range of 2:1 to 1:2, preferably of 1:1. An aspect ratio of the exit window shall be understood to be the ratio of its width to its height. The height of the exit window preferably is in the range of 2 mm to 10 m or preferably in the range of 0.5 cm to 5 m or preferably in the range of 1 cm to 1 m.

The optical element can be any optical element a person skilled in the art would use for a radiation source. If reference is made to an optical element hereinafter without specifying whether this concerns the first or a further optical element, this shall always refer to the first optical element. Preferably, the first optical element is selected from the group consisting of a lens, a reflector, an aperture, a prism, a mirror or a combination of at least two thereof. Also preferably, the radiation source comprises more than one optical element. The first optical element is preferred to be a lens. Also preferably, the first optical element is a lens selected from the group consisting of a biconvex lens, a plano-convex lens, a concave-convex lens, a biconcave lens, a plano-concave lens, a convex-concave lens or a combination of at least two thereof. The lens is preferred to be a biconvex lens. The optical element can comprise a material, preferably selected from the group consisting of glass, quartz, polymer, silicon or a combination of at least two thereof. The glass or the quartz can be any glass or quartz a person skilled in the art would use for an optical element. The polymer is preferably selected from the group consisting of polymethylmethacrylate (PMMA), polycarbonate (PC), cyclo-olefin (co)polymers, such as ethylene-norbornene copolymer, or a mixture of at least two thereof.

Preferably, the size of the optical element is in the range of 0.1 to 5,000 cm³ or preferably in the range of 0.5 to 3,000 cm³ or preferably in the range of 1 to 1,500 cm³. Preferably, the optical element has the same dimensions as the mount of the illuminant. Preferably, the optical element comprises at least one circumferential line of a shape selected from the group consisting of round, oval, triangular, quadrangular, pentagonal, hexagonal, multi-gonal, preferably with seven to twenty corners, or a combination of at least two thereof. Preferably, the optical element has a rectangular, square or oval shape. Preferably, the circumferential line of the optical element has the same shape and dimensions as the exit window of the mount of the illuminant.

The sensor can be any sensor a person skilled in the art would select for the radiation source. Any sensor allowing a change of a parameter of the optical element to be detected can be used as a sensor. In the scope of the invention, a parameter shall be understood to be a property of the optical element that can affect the radiation of the illuminant that interacts with the optical element. Preferably, the parameter is selected from the group consisting of temperature, shape, volume, position of the first optical element with respect to the illuminant or a combination of at least two thereof. In the scope of the invention, a change of a parameter of the optical element shall be understood to mean that the parameter of the optical element changes by a detectable increment over time, for example over the lifetime or over the operating time of the radiation source. Whether or not a change is detectable can depend on several factors. For example, the detectability of the change of the parameter depends on the sensitivity of the sensor. Depending on where the sensor is being used, the material property of the optical element or of the bracket can also have affect the detectability of the change of the parameter. Likewise, the type of the connection between optical element and bracket can have affect the detectability of the change of the parameter. Preferably, the sensor is selected from the group consisting of a temperature sensor, an extensometer, an optical sensor, a capacitative sensor, an inductive sensor or a combination of at least two thereof. Conventional sensors that are well-suited for use in the radiation source in terms of their performance and size can be used as sensors. The sensor can contact the optical element directly or indirectly by means of a further material, such as, e.g. a bracket. The further material is preferred to be a material that has similar thermal conductivity or expansion properties as a function of temperature as the first optical element. Preferably, the further material comprises a higher thermal conductivity than the material of the first optical element. Preferably, the further material comprises a thermal conductivity that is 2 to 1,000 times or preferably 3 to 800 times or preferably 5 to 500 times larger than that of the first optical element.

The temperature sensor can be any sensor that enables a temperature change or an absolute temperature in a place to be determined. Preferably, the temperature sensor is a sensor selected from the group consisting of a NTC thermistor based on metal oxides or semiconductors, a PTC thermistor based on a platinum, silicon or ceramic measuring resistor, a piezoelectric crystal, a pyroelectric material or a combination of at least two thereof. A PTC thermistor is preferred as temperature sensor. The temperature sensor preferably has a measuring range of 0 to 500° C. or preferably a measuring range of 10 to 450° C. or preferably a measuring range of 20 to 400° C. The temperature sensor preferably has a sensitivity in the range of 0.01 to 5° C. or preferably in the range of 0.05 to 0.9° C. or preferably in the range of 0.08 to 0.8° C.

Any sensor allowing a change in the shape, volume or position of the first optical element to be detected can be used as extensometer. If the expansion properties at different temperatures of the material are known, it is possible to deduct a temperature change or an absolute temperature in a place from the deformation of the material. The extensometer can be used to detect minute spatial shifts of a material that contacts the extensometer. Preferably, the extensometer is selected from the group consisting of an analogue position sensor, an incremental position sensor or a combination thereof. Preferably, the extensometer is designed as a resistive extensometer, for example, a strain gauge, as a laser extensometer or as an optical extensometer. Examples of a strain gauge include the “QF” series made by TML Tokyo Sokki Kenkyujo Co., Ltd. The extensometer is preferably designed appropriately such that it can detect position or shape changes of the optical element in at least one direction of space in the range of 0.001 to 0.1 mm or preferably in the range of 0.005 to 0.08 mm or preferably in the range of 0.008 to 0.05 mm. Preferably the resistive extensometer has a sensitivity k in the range of −200 to 200 or preferably in the range of −190 to 190 or preferably in the range of −180 to 180. Whereby k=(Delta R/R)/(Delta L/L); whereby R=measured value; L=length; Delta L=change in length. Depending on the sensor type, R is a measuring value selected from the group consisting of a resistor, a voltage, a capacitance or a combination of at least two thereof. The length L refers to a length of the optical element as evident at the beginning of the use of the radiation source. The change in length, Delta L, indicates the change of said length during the time of use of the radiation source.

The extensometer can be arranged either directly on the optical element or can be connected indirectly to the optical element. The extensometer is connected to the optical element, preferably over in the range of 0 to 50% or preferably in the range of 1 to 40% or preferably in the range of 2 to 30% of the total surface of the optical element.

Any sensor allowing a change in the shape, volume or position of the first optical element to be detected by optical means can be used as an optical sensor. Any sensor that uses light to render a position of a material detectable can be used for this purpose. The optical sensor is preferably selected from the group consisting of a camera, a photodiode sensor or a combination thereof. Preferably, the optical sensor is appropriately oriented with respect to the optical element such that no direct radiation impinges on the optical sensor. Preferably, the optical sensor is arranged between the exit window and the optical element in the radiation source. Preferably, the optical sensor is adapted to detect the shape of the optical element. Preferably, the optical sensor has a sensitivity in the range of 0.001 to 0.1 mm or preferably in the range of 0.005 to 0.08 mm or preferably in the range of 0.008 to 0.05 mm. Alternatively or additionally, the optical sensor can be designed appropriately such that it detects a quantity of light that is representative of the functional mode of the radiation source. In this context, the optical sensor is preferred to have a sensitivity in the range of 0.0001 to 0.1 Watt/cm².

The capacitive sensor can be any sensor that allows a change in the shape, volume or position of the first optical element to be detected by capacitive means. Examples of a capacitive sensor include the MHR product line made by Althen Mess- and Sensortechnik, Kelkheim, Germany. A small sensor is preferred, for example the MHR 005 from said product line.

The inductive sensor can be any sensor that allows a change in the shape, volume or position of the first optical element to be detected by inductive means. Examples of an inductive sensor include the Centrinex product line made by Sicatron GmbH & Co. KG, Hagen, Germany.

Preferably, the sensor is connected directly or indirectly to the optical element. In the scope of the invention, directly connected shall be understood to mean that at least one part of the materials of the sensor and of the optical element contact each other directly. This can be effected, for example, by gluing the sensor to at least a part of the optical element. An indirect connection can be effected, for example, by clamping the optical element in a bracket, whereby the bracket is being connected to the sensor. Connecting the sensor directly to the optical element allows the property of the optical element to be measured by the sensor to be determined and/or monitored directly. Accordingly, for example a temperature sensor and/or an extensometer can be used to determine the temperature and/or the expansion of the optical element directly. With the sensor being indirectly connected to the optical element, the detection does not proceed directly on the optical element, but rather a property of, e.g., the bracket is determined in order to deduct the condition of the optical element. The indirect connection between sensor and optical element is preferred, in particular if the characteristics of the optical element would be affected by direct connection. The sensor can be arranged in various positions inside the radiation source with the optical element. Preferably, the sensor is arranged on the side of the optical element that faces away from the illuminant. In an alternative preferred arrangement of the sensor, the sensor is arranged on the side of the optical element that faces the illuminant.

According to the invention, the sensor is also designed appropriately such that it determines a parameter of the optical element over time. Said parameter affects an optical property of the radiation source. Preferably, the parameter of the optical element determined by the sensor is selected from the group consisting of the temperature, the volume, the thickness, the shape, the change of a refractive index, each, of the optical element or a combination of at least two thereof. Preferably, determining said parameters allows the optical properties of the optical element to be deducted. Accordingly, it is known, e.g., that the refractive index of a material can change with temperature. Said change of the refractive index can lead to the light that is being guided through the optical element being deflected differently at a first temperature than at a further temperature. As a result, e.g. the distribution of radiation of the radiation source can change. The distribution of radiation is a measure of the homogeneity of a radiation source. The distribution of radiation shall be understood to be the distribution of the radiation intensities at various points on a surface that is illuminated or penetrated by light from the radiation source. A distribution of radiation being optimally homogeneous shall be understood to correspond to a deviation of the radiation intensity at various points of a surface illuminated or penetrated by light of no more than 10%, preferably of no more than 8% or preferably no more than 5%, relative to the average radiation intensity at the entire surface to be illuminated or penetrated by light. Accordingly, determining, e.g., the temperature at the optical element allows the refractive index of the optical element to be deducted and thus allows the homogeneity of the distribution of radiation of the radiation source to be deducted. The change in refractive index is most often elicited by the change in the thickness of the material at different sites in the optical element that may take place due to temperature changes. Accordingly, it is also feasible to measure the thickness, volume or shape of the optical element based on a temperature change to deduct the optical properties of the optical element and thus the quality of the distribution of radiation of the radiation source. Accordingly, the change of the parameter can be determined by determining either the temperature or a shape change on the optical element. Accordingly, the sensor is thus used to determine a change of a parameter over time, as described above. In this context, the time is preferred to be the operating time of the radiation source, namely the time period since the radiation source was started-up. Preferably, the sensor determines measuring values during the operating time of the radiation source. Preferably, the time over which the parameter is determined is in the range of 1 minute to 20,000 hours or preferably in the range of 1 hour to 18,000 hours or preferably in the range of 10 hours to 15,000 hours. In order to use the measurements of the sensor over time to monitor the distribution of radiation, it is preferred to compare the corresponding measuring value of the sensor at a certain point in time to a nominal value stored in an analytical unit. Preferably, the sensor is appropriately connected to the analytical unit in this context such that the measuring values determined by the sensor can be transmitted rapidly, for example, each second to each minute, to the analytical unit. If the measured measuring value of the sensor deviates from the stored nominal value by more than a given threshold value, it is preferable to exert an influence on the cause of the deviation in the form of a resulting measure. Preferably, the resulting measure is selected from the group consisting of cooling the radiation source, cooling the optical element, switching off the radiation source, exchanging the optical element, reducing the energy input to the optical element or a combination of at least two thereof. Preferably, the radiation source is being switched off during the determination of the change of a parameter of the optical element by more than the given threshold value.

Using a sensor that monitors an expansion of the first optical element, it is preferred to undertake a resulting measure if a deviation DeltaL/L of the shape of the optical element in at least one direction of space is in the range of 5*10⁻⁴ to 5*10⁻² or preferably in the range of 3*10⁻⁴ to 3*10⁻² or preferably in the range of 10⁻³ to 10⁻², whereby L is an expansion of the optical element in one of the three directions of space. Using a sensor that monitors the temperature of the first optical element, it is preferred to undertake a resulting measure if a deviation from a predetermined nominal temperature Tₛₒₗₗ preferably is in the range of 20 to 50° C. or preferably is in the range of 25 to 35° C. or preferably is in the range of 27 to 32° C. Preferably, Tₛₒₗₗ is in the temperature range of 20 to 600° C. or preferably in the range of 30 to 400° or preferably in the range of 40 to 300° C.

In a preferred embodiment of the radiation source, the first optical element comprises a bracket, whereby the sensor is connected to the optical element by means of the bracket. The bracket preferably has a relative thermal conductivity λ in the range of 1 to 1,000 W/(m*K) or preferably in the range of 5 to 420 W/(m*K) or preferably in the range of 10 to 400 W/(m*K). The bracket preferably has a coefficient of linear expansion a in the range of 1*10⁻⁶ to 50*10⁻⁶/K or preferably in the range of 2*10⁻⁶ to 40*10⁻⁶/K or preferably in the range of 3*10⁻⁶ to 30*10⁻⁶/K. Preferably, the bracket comprises in the range of 10 to 100% by weight or preferably in the range of 20 to 100% by weight or preferably in the range of 50 to 100% by weight of the further material, relative to the total weight of the bracket. The bracket is preferably connected appropriately to the optical element such that at least one, preferably at least two or preferably all of the following properties are met: a. the bracket surrounds at least 30% of the first optical element along the circumferential line of the optical element; b. the bracket extends along the longest circumferential line of the optical element; c. the bracket covers less than 10% of the surface of the optical element; d. the bracket is connected appropriately to the first optical element such that the bracket interferes and/or interacts as little as possible with the path of light of the light radiated to the optical element by the illuminant; e. the bracket contacts the first optical element directly; f. the optical properties of the optical element are not affected by the bracket at all or not in a measurable and reproducible manner; and g. the bracket is made up of a material having the lowest possible thermal expansion coefficient.

A lowest possible thermal expansion coefficient shall be understood to be a coefficient of linear expansion a of less than 40*10⁻⁶/K.

Preferably, the bracket comprises the feature combination selected from the group consisting of a. b; a. c.; a. d., a. e., a. f., a. g., b. c., b. d., b. e., b. f., b. g., c. d., c. e., c. f., c. g., d. e., d. f., d. g., e. f., e. g., f. g., a. b. c., a. b. d., a. b. e., a. b. f., a. b. g., a. c. d., a. c. e., a c. f., a. c. g., a. d. e., a. d. f., a. d. f., a. d. e., a. d. f., a. d. g., a. e. f., a. e. g., a. f. g., b. c. d., b. c. e., b. c. f., b. c. g., b. d. e., b. d. f., b. d. g., b. e. f., b. e. g., c. d. e., c. d. f., c. d. g., c. e. f., c. f. g., d. e. f., d. f. g., e. f. g., a. b. c. d., a. c. e., a. b. c. f., a. b. c. g., a. b. d. e., a. b. e. f., a. b. f. g., a. c. d. e., a. c. e. f., a. c. f. g., a. d. e. f., a. d. e. g., a. e. f. g., a. b. c. d. e., a. b. c. d. f., a. b. c. d. g., a. b. c. e. f., a. b. c. e. g., a. b. d. e. f., a. b. d. f. g., a. b. e. f. g., a. c. d. e. f., a. c. d. f. g., a. d. e. f. g., b. c. d. e. f., b. c. d. e. g., b. c. d. f. g., b. d. e. f. g., c. d. e. f. g.

Preferably, it is the object of the bracket to hold and to position the first optical element precisely in order to prevent the first optical element from moving during the use of the radiation source. The bracket is preferably designed appropriately such that it can affix the optical element in any direction of space at a precision in the range of 0.01 to 1 mm, preferably in the range of 0.02 to 0.8 mm or preferably in the range of 0.05 to 0.5 mm. There can be a direct or and an indirect connection between the bracket and the first optical element. A direct connection shall be understood to be a direct contact of the materials of the first optical element and of the bracket. This can take place, for example, by simple stacking, clamping, holding or a combination thereof. The indirect connection can take place, for example, by gluing the bracket to the first optical element. Preferably, the glue for gluing is selected from the group consisting of an epoxy, a polyurethane, a silicone, an unsaturated polyester, a methylmethacrylate or a combination of at least two thereof. Preferably, the connection between bracket and optical element is designed appropriately such that a temperature transfer between the two can take place without additional thermal resistance.

In a preferred embodiment of the radiation source, the bracket surrounds the first optical element along a circumferential line over at least 50% of the circumferential line. Preferably, the bracket surrounds the first optical element along a circumferential line over 100% of the circumferential line. Preferably, the bracket surrounds the first optical element along its circumferential line that has the greatest length. Preferably, the bracket surrounds the first optical element along a circumferential line that is situated perpendicular to the main emission direction of the illuminant. Also preferably, the bracket surrounds the first optical element along a circumferential line, over 100% of said circumferential line, that is situated perpendicular to the main emission direction of the illuminant.

In a preferred embodiment of the radiation source, the bracket comprises at least 50% by weight, preferably at least 60% by weight or preferably at least 70% by weight, relative to the total weight of the bracket, of a metal, a ceramic material, a cermet, a polymer, a silicone or a combination of at least two thereof.

The metal can be any metal a person skilled in the art would select for this purpose. Preferably, the metal is a metal with a high thermal conductivity.

In a preferred embodiment of the radiation source, the metal comprised by the bracket is selected from the group consisting of iron, steel, copper, aluminium, magnesium, titanium, tungsten, nickel, tantalum, niobium, an alloy of at least two of these metals, an alloy of copper and zinc, lead, nickel, manganese or silicon or a mixture of at least two thereof. Preferably, the metal is aluminium or steel, for example VA steel, such as V2A or V4A steel. Also preferably, the bracket consists of at least 90% by weight aluminium, relative to the total weight of the bracket.

The ceramic material can be any ceramic material a person skilled in the art would select for this purpose. Preferably, the ceramic material is selected from the group consisting of aluminium nitride (AlN), aluminium oxynitride (AlON), aluminium oxide (Al₂O₃), alumosilicates (Al₂SiO₅), a ceramic material as mentioned for the cermet or a mixture of at least two thereof.

In the scope of the invention, “cermet” shall be understood to refer to a composite material made of one or more ceramic materials in at least one metallic matrix or a composite material made of one or more metallic materials in at least one ceramic matrix. For production of a cermet, for example, a mixture of at least one ceramic powder and at least one metallic powder can be used to which, for example, at least one binding agent, such as methyl cellulose, and, if applicable, at least one solvent, such as an alcohol, can be added. The metal for the cermet can be selected from the group consisting of iron (Fe), stainless steel, platinum (Pt), iridium (Ir), niobium (Nb), molybdenum (Mo), tungsten (W), titanium (Ti), cobalt (Co), chromium (Cr), a cobalt-chromium alloy, tantalum (Ta), vanadium (V) and zirconium (Zr) or a mixture of at least two thereof, whereby titanium, niobium, molybdenum, cobalt, chromium, tantalum, zirconium, vanadium and the alloys thereof are particularly preferred. The ceramic material, in particular for the cermet, can be selected from the group consisting of aluminium oxide (Al₂O₃), zirconium dioxide (ZrO₂), hydroxyl apatite, tricalcium phosphate, glass ceramics, aluminium oxide-toughened zirconium oxide (ZTA), zirconium oxide-containing aluminium oxide (ZTA—Zirconia Toughened Aluminum—Al₂O₃/ZrO₂), yttrium-containing zirconium oxide (Y-TZP), aluminium nitride (AlN), titanium nitride (TiN), magnesium oxide (MgO), piezoceramics, barium (Zr, Ti) oxide, barium (Ce, Ti) oxide and sodium-potassium-niobate or a mixture of at least two thereof.

The polymer is preferred to be the same polymer of which the first optical element is made. The polymer is preferably selected from the group consisting of polymethylmethacrylate (PMMA), polycarbonate (PC), cyclo-olefin (co)polymers, such as ethylene-norbornene copolymer, or a mixture of at least two thereof.

The silicone is preferably selected from the same group as described for the first optical element.

In a preferred embodiment of the radiation source, the sensor is selected from the group consisting of a temperature sensor, an extensometer or a combination thereof.

In a preferred embodiment of the radiation source, the sensor is appropriately connected to the optical element such that more than 10% or preferably more than 15% or preferably more than 20% of the radiation emitted by the illuminant impinges on the sensor. The sensor is preferably illuminated directly by the illuminant in said embodiment. This is advantageous in that the sensor is exposed to an amount of light that is directly correlated to the amount of light on the first optical element, preferably in the wavelength ranges and in the ranges of the amount of light that are specified as being preferred for the radiation source.

In a further preferred embodiment of the radiation source, the sensor is appropriately connected to the optical element such that less than 20% or preferably less than 15% or preferably less than 10% of the radiation emitted by the illuminant impinges on the sensor. The sensor is preferably illuminated indirectly by the illuminant in said embodiment. Preferably, the bracket is situated between the illuminant and the sensor. Accordingly, the sensor is situated in the shadow of the bracket. This is advantageous in that the sensor is not being overloaded by the radiation of the illuminant.

It is preferred to attach a photodiode to the bracket for determining the amount of light emitted by the illuminant. Preferably, the photodiode is initially exposed to multiple known amounts of light in order to determine a calibration curve. The calibration curve can be used during the service life of the radiation source to determine the exact amount of light on the bracket. If a temperature sensor is used to determine the change of a parameter of the optical element, the impinging amount of light and the temperature determined by the sensor can be used to deduce the temperature range in the middle of the main emission direction. Preferably, the measured temperature can be used to calculate whether or not the the shape of the first optical element has changed as compared to its original shape at room temperature.

In a preferred embodiment of the radiation source, the sensor is appropriately connected to the optical element such that an expansion of the first optical element can be determined in all three directions of space. Preferably, the expansion of the first optical element in all three directions of space can be measured through the use of, for example, an extensometer. Preferably, the extensometer is connected appropriately to the first optical element such that a part of the extensometer extends in each direction of space. Preferably, the extensometer is connected appropriately to the first optical element such that at least a part of the extensometer extends in the direction of the main emission direction, at least a part extends perpendicular to the emission direction, and at least a part extends perpendicular to the perpendicularly extending direction. Preferably, at least 10% or preferably at least 15% or preferably at least 20% of the extension surface of the extensometer each extend in the main emission direction and in each of the two directions oriented perpendicular to it.

In a preferred embodiment of the radiation source, the radiation source comprises a number of sensors that is in the range of 1 to 100 or preferably in the range of 2 to 80 or preferably in the range of 3 to 50. Preferably, the sensor comprises the 2 to 100 sensors in the form of a row or chain. Preferably, the individual sensors in this chain or row are connected to each other by means of an electrical connection. Said chain or row can be connected to an analytical unit by its ends by means of an electrical connection. Preferably, the plurality of sensors is provided as temperature sensors.

In a preferred embodiment of the radiation source, the sensor is arranged on the edge of the optical element. Preferably, the edge is considered to be that region of the optical element that is situated as far away as possible from the main emission direction of the illuminant, which preferably extends through the centre of the optical element. Preferably, the region on the circumferential line that is as far away as possible from the main emission direction of the illuminant, which extends perpendicular to the main emission direction, is referred to as the edge.

In a preferred embodiment of the radiation source, the sensor surrounds at least the surface of the first optical element that is situated perpendicular to a main emission direction of the illuminant.

In a preferred embodiment of the radiation source, the sensor encloses the first optical element along a circumferential line of the first optical element. Preferably, the sensor encloses the first optical element along a circumferential line of the first optical element, at the place at which the circumference of the first optical element is the largest.

In a preferred embodiment of the radiation source, the radiation source comprises at least three sensors. Preferably, all sensors are connected directly or indirectly to the first optical element. Also preferably, the at least three sensors are arranged appropriately about the first optical element such that they define a maximally sized surface.

In a preferred embodiment of the radiation source, the at least three sensors are arranged in a plane, whereby the largest possible surface defined by the sensors comprises at least one third, preferably at least half or preferably at least three quarters or preferably at least 90% of the surface of the optical element that is situated in the same plane as the sensors.

In a preferred embodiment of the radiation source, the length of the sensor corresponds at least to the length of the largest external circumference of the optical element. The length of the sensor shall be understood, for example, to be the longitudinal extension of an extensometer or the longitudinal extension of a sensor chain of the type described above.

In a preferred embodiment of the radiation source, the first optical element is selected from the group consisting of a lens, a reflector, an aperture, a prism, a mirror or a combination of at least two thereof.

In a preferred embodiment of the radiation source, the radiation source comprises a further optical element. The further optical element can be any optical element a person skilled in the art would use for a radiation source. Preferably, the further optical element is selected from the group of optical elements specified for the first optical element. Moreover, the further optical element can be combined with additional optical elements from the same group. Preferably, the further optical element is a reflector or a lens. Preferably, the further optical element is a converging lens, in particular a plano-convex lens. Preferably, the further optical element is appropriately connected to the illuminant such that it also is being cooled by the cooling unit.

In a preferred embodiment of the radiation source, the illuminant emits light in the wavelength range of 100 nm to 10 μm, preferably in the range of 120 nm to 9 μm or preferably in the range of 140 nm to 8 μm. Also preferably, the illuminant emits light in the wavelength range of 780 nm to 10 μm. Also preferably, the illuminant emits light in the wavelength range of 150 nm to 420 nm or preferably in the range of 160 to 410 nm or preferably in the range of 170 to 400 nm.

A further subject matter of the invention is a method for producing a product, comprising the steps of: i. providing an educt; ii. providing a radiation source according to any one of the claims 1 to 18; and iii. illuminating the educt with the radiation source in order to obtain the product.

The provision of the educt in step i. can take place in any way and manner known to a person skilled in the art. Preferably, the educt is provided on a mobile support. Preferably, the mobile support is selected from the group consisting of a conveyor belt, a belt that is being transported from roller to roller, a shaker or a combination of at least two thereof. Preferably, the educt on the mobile support is being moved past the radiation source such that the light of the radiation source impinges on the educt. Preferably, the dwelling time of the educt exposed to the influence of the radiation source is selected to be in the range of 0.1 second to 10 hours or preferably in the range of 10 seconds to 1 hour or preferably in the range of 30 seconds to 10 minutes.

The educt can be any educt that undergoes a change of state when exposed to the influence of the radiation source. Preferably, the educt is selected from the group consisting of an object, a liquid phase, a space or a combination of at least two thereof.

The provision of the radiation source in step ii. can take place in any way and manner a person skilled in the art would conceive for this purpose. Preferably, the radiation source is provided appropriately such that the amount of light emitted by the radiation source that impinges on the educt is maximised.

The illumination of the educt can take place in any way and manner a person skilled in the art would select for this purpose. Preferably, the educt is illuminated appropriately by the illuminant of the radiation source such that it can be converted to the product at an optimised dwelling time. Preferably, the dwelling time of the educt exposed to the influence of the radiation source is selected to be in the range of 1 millisecond to 10 hours or preferably in the range of 10 milliseconds to 1 hour or preferably in the range of 30 milliseconds to 10 minutes.

In a preferred embodiment of the method, the product is obtained through a change of state of the educt. The change of state is preferably selected from the group consisting of drying a wet surface, hardening a varnish, illuminating a dark space or the combination of at least two thereof.

In a preferred embodiment of the method, the product is obtained from the educt by means of a conversion, i.e. a chemical reaction of two starting molecules.

Preferably, the educt is selected from the group consisting of a liquid phase, a wet object, a first state. The liquid phase is preferably selected from the group consisting of a mixture of at least two chemicals or materials, a solution of a polymer that is non-crosslinked or a mixture thereof.

In a preferred embodiment of the method, the product is selected from the group consisting of a liquid phase, an object, a change of state of the educt. The liquid phase is preferably selected from the group consisting of a mixture of at least two chemicals or materials that have reacted with each other, a solution of a polymer that is non-crosslinked or a combination thereof.

A further object of the invention is the use of a sensor for homogenisation of the beam distribution of a radiation source according to any one of the embodiments |1| to |19|. It is preferable to use a sensor of the type described above in the context of the radiation source. The homogenisation of the beam distribution of the radiation source preferably leads to homogeneous illumination of an educt, whereby the deviation of the beam distribution of the illuminant from a nominal beam distribution is being determined and the illuminant is being switched of if the beam distribution deviates by more than 10% from the nominal beam distribution.

A further object of the invention is the use of a radiation source according to any one of the embodiments |1| to |19| to increase the efficiency of conversions or changes of state of educts to products. The efficiency of the conversion or change of state of educts to products is preferably attained by even a minimal deviation of the measuring values of the sensor from a predetermined nominal value leading to a resulting measure. Preferably, the resulting measure is selected from the group consisting of cooling the radiation source, cooling the optical element, switching off the radiation source, exchanging the optical element, reducing the energy input to the optical element or a combination of at least two thereof. Preferably, the radiation source is being switched off during the determination of the change of a parameter of the optical element by more than the given threshold value.

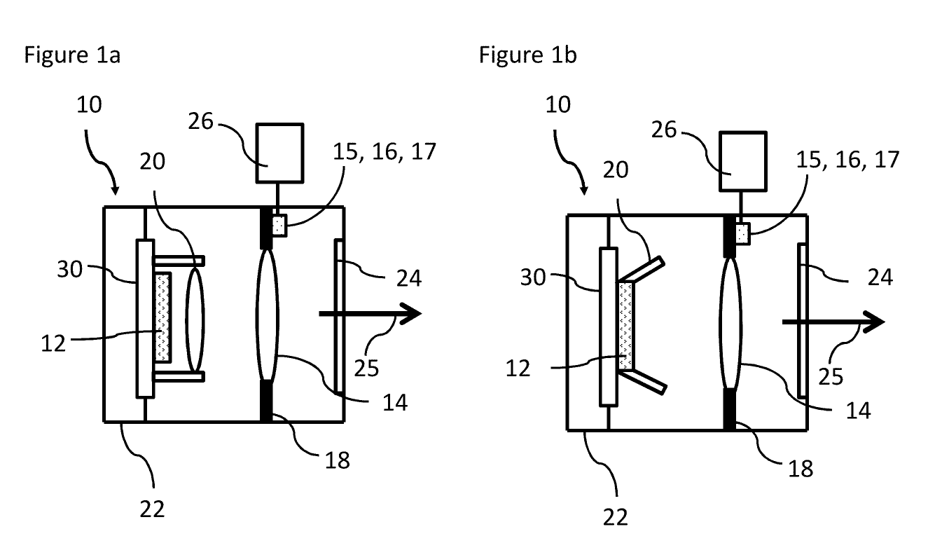

FIG. 1a shows a schematic view of a radiation source 10 that comprises a housing 22, in which an illuminant 12 is arranged that can be temperature-controlled by means of a cooling unit 30. The light of the illuminant 12 is bundled in the direction of the first optical element 14 by means of a further optical element 20. The first optical element 14, presently in the form of a convex-convex converging lens 14, affects the propagation of the light from the illuminant 12, preferably appropriately such that an optimally homogeneous wave front exits from the housing 22 through the window 24 of the radiation source 10 in order to attain an optimally homogeneous distribution of radiation on a surface to be illuminated (not shown presently). The light preferably moves in the main emission direction 25 from the illuminant 12 in the direction of the exit window 24. On its way to the exit window 24, the light is shaped into a homogeneous wave front by the first optical element 14 and the further optical element 20. Preferably, the light is used to homogeneously irradiate an educt, for example in the form of a space, an object or a liquid, in order to obtain a product. Accordingly, for example, not shown presently, a series of objects on a conveyor belt moving with respect to the radiation source 10 can be irradiated in order to attain, for example, a drying of the object or of its surface. The first optical element 14 is held in its position in front of the illuminant 12 by means of a bracket 18. The bracket 18 is appropriately connected to the first optical element 14 such that, on the one hand, the first optical element 14 is being held precisely and such that, on the second hand, a heat transfer from the first optical element 14 to the bracket is as high as possible. For this purpose, the bracket 18 preferably has a relative heat conductivity λ in the range of 1 to 1,000 W/(m*K). In this example, the sensor 15 is connected to the bracket 18. It is also conceivable to directly connect the sensor 15 to the first optical element 14. The sensor 15 is connected to an analytical unit 26 by means of a cable. Said connection could also take place in wireless manner if the sensor 15 is equipped with an emitter or if the transmission of measuring data of the sensor takes place by inductive means. In this example, the sensor 15 is arranged on the bracket 18 on the side facing away from the illuminant 12. In another embodiment, not shown presently, the sensor 15 can just as well be arranged on the bracket 18 on the side facing the illuminant 12.

The radiation source 10 in the schematic view of FIG. 1b is designed alike the radiation source 10 in FIG. 1a except that the light emitted by the illuminant 12 is guided onto the first optical element 14 via a reflector as further optical element 20.

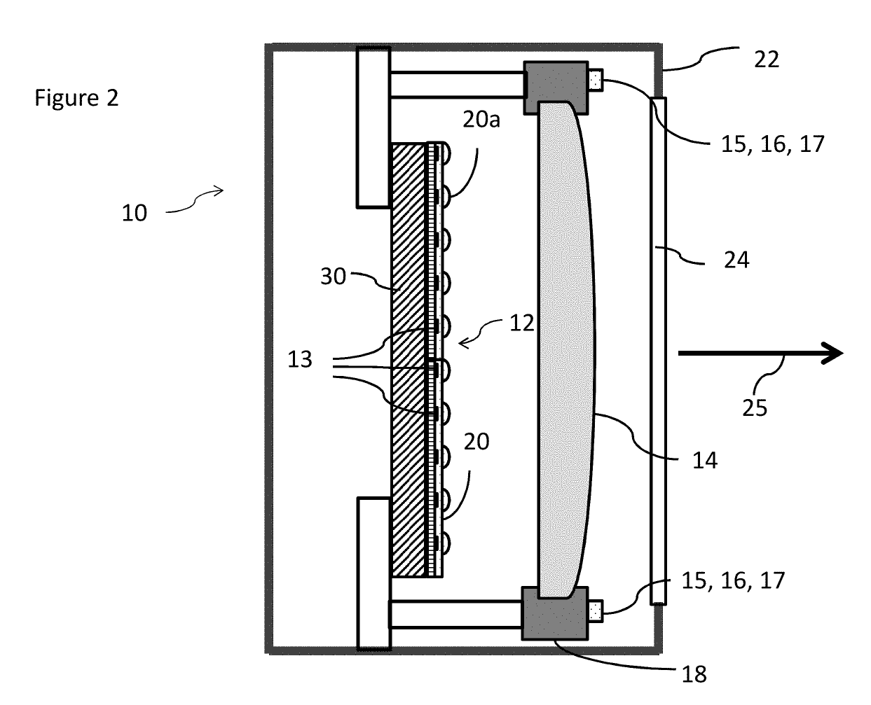

The radiation source 10 shown in the schematic view of FIG. 2 has the same design as the radiation source 10 of FIG. 1a except that the illuminant 12 consists of multiple light sources 13. Preferably, the plurality of light sources 13 are LEDs of an LED array that can contain more than 1,000 individual LEDs. The first optical element 14 comprises a plano-convex lens 14 which preferably is designed appropriately such that the light from the light sources 13 is being aligned parallel to the main emission direction 25. The first optical element 14 is preferred to be designed in a single part. The plurality of light sources 13 is presently also being cooled by means of a cooling unit 30. The sensor and/or sensors 15, 16, 17 can also be connected to an analytical unit 26 (not shown presently). Preferably, this is a temperature sensor 17. Alternatively, an extensometer 16 can be used just as well. The bracket 18 encompasses the first optical element, preferably completely. This is not shown presently since the view shown is a cross-section through the radiation source 10. The housing 22, together with the exit window 24, completely surrounds the illuminant 12, the bracket 18, the sensor 15, 16, 17, and the first optical element as well as the further optical element 20. Aside from the multitude of light sources 13, the further optical element 20 of the radiation source 10 comprises, for each light source 13, a shape with optical properties 20a in the form of a multitude of convex lenses 20a in the first optical element 20. By this means, the light of each light source 13 can be changed individually in terms of its propagation, preferably can be bundled in the main emission direction 25, by a shape with optical properties 20a of the first optical element 20.

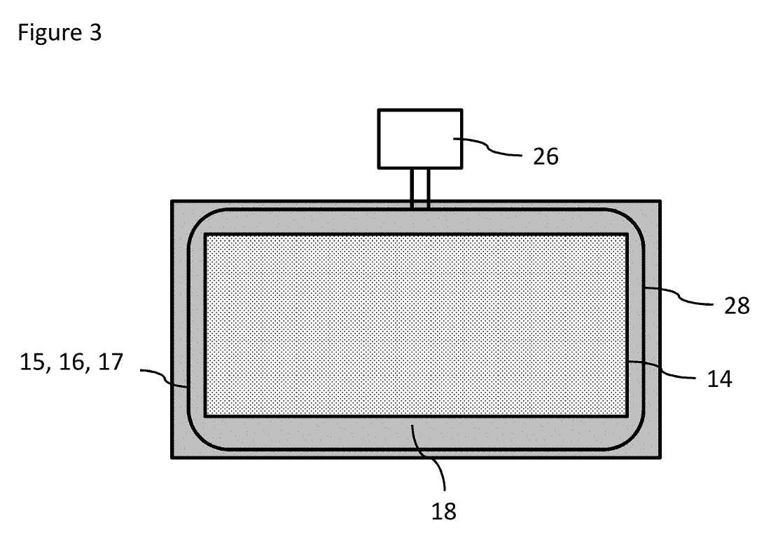

FIG. 3 shows a schematic view of an arrangement of a first optical element 14, in the form of a lens 14 in a bracket 18. The bracket 18 is arranged completely circumferential about a circumferential line 28 of the lens 14, i.e. it encloses the first optical element (e.g., lens) 14 completely. An extensometer or temperature sensor 15, 16, 17 is arranged on the bracket 18 over the entire circumferential line 28 of the bracket 18, and thus of the first optical element (e.g., lens) 14 as well. The materials of the first optical element 14 and of the bracket 18 are matched to each other appropriately such that the sensor 15, 16, 17 can measure a change of the optical properties of the optical element 14.

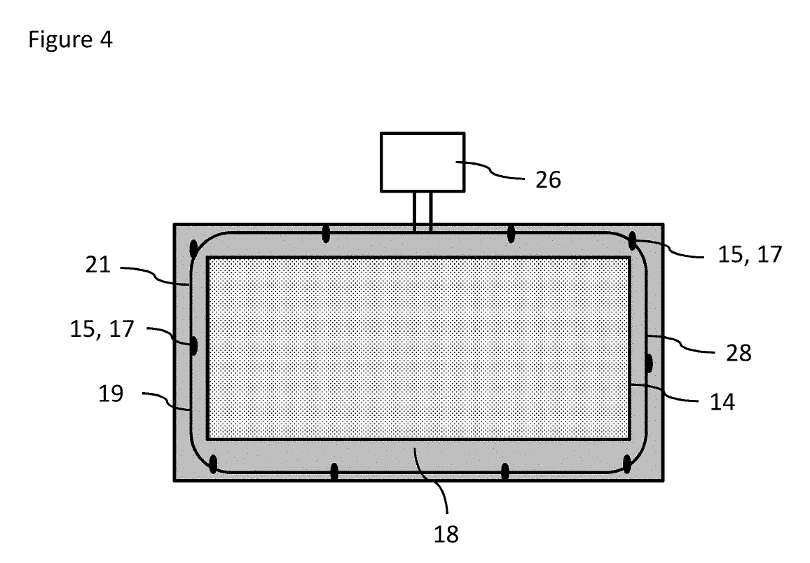

FIG. 4 shows a schematic view of another arrangement of first optical element 14, bracket 18, and a multitude of sensors 15. Preferably, the sensors are temperature sensors 17 that are connected to each other by means of an electrical cable 21 in order to be able to transmit the measuring values of the sensors 15 to the analytical unit 26. Accordingly, said arrangement forms a sensor chain 19.

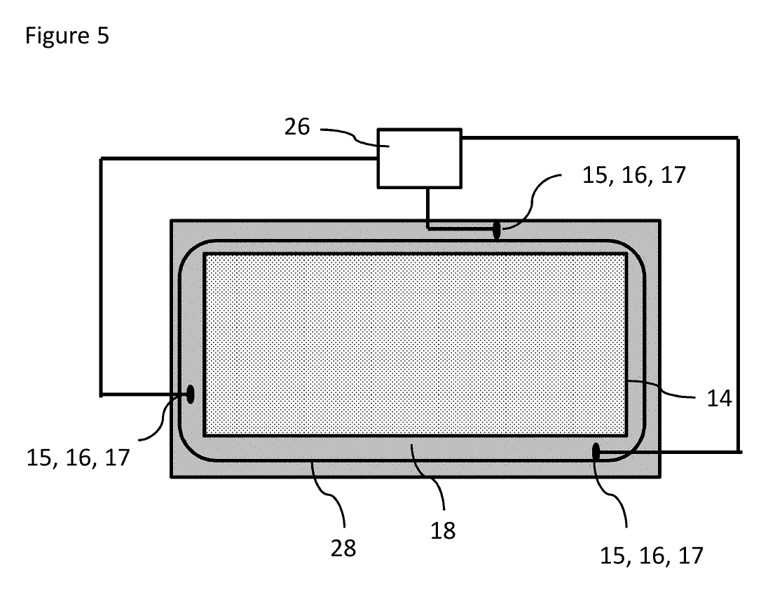

FIG. 5 also shows a schematic view of a first optical element 14 having a bracket 18 and a multitude of sensors 15, i.e. three sensors 15 in the present case. Preferably, this concerns temperature sensors 17 that are connected individually to the analytical unit 26 by means of electrical cables 21.

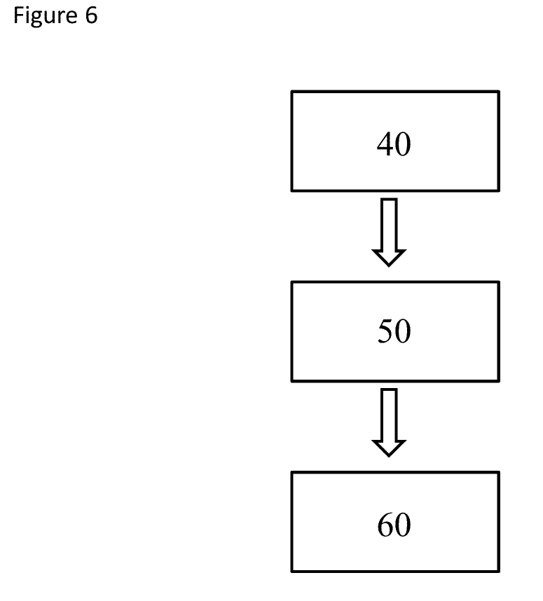

FIG. 6 shows a schematic view of the method for producing a product from an educt. The educt is provided in a first step i. 40. This can take place, for example, in the form of a moist or wet object on a conveyor belt. In a second step ii. 50, the radiation source 10 is provided appropriately such that the educt is illuminated optimally homogeneously. In a third step iii. 60, the illumination of the educt is used so that the educt is changed into a product.

Although the invention is illustrated and described herein with reference to specific embodiments, the invention is not intended to be limited to the details shown. Rather, various modifications may be made in the details within the scope and range of equivalents of the claims and without departing from the invention.

### LIST OF REFERENCE NUMBERS

10 Radiation source
12 Illuminant
13 Light source
14 First optical element, lens, converging lens
14a Bulge
15 Sensor
16 Extensometer
17 Temperature sensor
18 Bracket
19 Sensor chain
20 Further optical element
20a Shape with optical properties|[AN2], convex lens
21 Electrical cable
22 Housing
24 Window/exit window
25 Main emission direction
26 Analytical unit
28 Circumferential line (of the first optical element)
30 Cooling unit
40 First step i.
50 Second step ii.
60 Third step iii.

1. A radiation source comprising:
an illuminant;
a first optical element; and
a sensor,
whereby the sensor is designed appropriately and is connected to the first optical element appropriately such that the sensor can be used to determine a change of a parameter of the first optical element over time, whereby the parameter affects an optical property of the radiation source.

2. The radiation source of claim 1, whereby the first optical element comprises a bracket and whereby the sensor is connected to the first optical element by means of the bracket.

3. The radiation source of claim 2, whereby the bracket surrounds the first optical element along a circumferential line over at least 50% of the circumferential line.

4. The radiation source of claim 3, whereby the bracket comprises at least 50% by weight of a metal, a ceramics, a cermet, a polymer or a combination of at least two thereof, relative to a total weight of the bracket.

5. The radiation source of claim 1, whereby the sensor is selected from the group consisting of a temperature sensor, an extensometer, an optical sensor, a capacitative sensor, an inductive sensor or a combination of at least two thereof.

6. The radiation source of claim 1, whereby the sensor is appropriately connected to the first optical element such that less than 20% of the radiation emitted by the illuminant impinges on the sensor.

7. The radiation source of claim 1, whereby the radiation source includes a plurality of the sensors in the range from 1 to 100.

8. The radiation source of claim 1, whereby the sensor is arranged on an edge of the first optical element.

9. The radiation source of claim 1, whereby the sensor surrounds at least a surface of the first optical element that is situated perpendicular to a main emission direction of the illuminant.

10. The radiation source of claim 1, whereby the sensor encloses the first optical element along a circumferential line of the first optical element.

11. The radiation source of claim 1, whereby a length of the sensor corresponds at least to a length of the largest outer circumference of the first optical element.

12. The radiation source of claim 1, whereby the radiation source includes a further optical element.

13. A method for producing a product, the method comprising the steps of:
i. providing an educt;
ii. providing a radiation source according to claim 1; and
iii. illuminating the educt with the illuminant in order to obtain the product.

14. The method of claim 13, wherein the method includes using the sensor for homogenisation of a radiation distribution of the radiation source.

15. The method of claim 13, wherein the method includes using the radiation source to increase an efficiency of conversions or changes of state of educts to products.
